(19) United States
(12) Patent Application Publication
(10) Pub. No.: US 2006/0239555 A1
(43) Pub. Date: Oct. 26, 2006

(54) System and method for differentiating pictures and texts

(75) Inventor: Wang Zhuoya, Taipei (TW)

Correspondence Address: BRUCE H. TROXELL, SUITE 1404, 5205 LEESBURGH PIKE, FALLS CHURCH, VA, 22041, US

(73) Assignee: Destiny Technology Corporation

(21) Appl. No.: 11/113,183

(22) Filed: Apr. 25, 2005

(51) Int. Cl. G06K 9/34; G06K 9/56; G06K 9/62

(52) U.S. Cl. 382/176; 382/224; 382/205

(57) ABSTRACT

A system and method for differentiating pictures and texts includes, first, dividing an image corresponding to an image file to a plurality of unit areas of the same size each containing a plurality of pixels of the same number; generating a threshold by a threshold setting module based on the relationship between a gray-level and quantity; a picture text differentiating module sequentially performing statistics of the gray-levels of the pixels of the unit areas; sequentially comparing the gray-levels with the threshold; totaling the times that the gray-level equals to the threshold; and the picture text differentiating module comparing the times of equality with a preset comparison value to differentiate whether the data corresponding to the unit area is picture data or text image data.

### BACKGROUND OF THE INVENTION

(1) Field of the Invention

The invention relates to a system for differentiating pictures and texts.

(2) Description of the Prior Art

In the process of image files, how to differentiate image data and text image data so that they can be processed separately is an important issue. Data processing characteristics of the image data and text image data are different. For instance, in the image file processing of some image processing equipment such as copiers, if the picture and text are separated in advance, picture development result improves. In some cases, there is a greater difference between picture data bits and text image data bits (the data bits of the picture is much greater than the text). If the picture data and the text image data can be separated properly, an improved transmission efficiency can be achieved, especially in the Internet which has limited bandwidth resources.

The conventional techniques on space management include searching point, line and border method and region growing method. On frequency domain, Fourier transformation and wavelet transformation approaches are generally adopted. The space domain means the plane picture. This approach directly processes the individual pixels of the picture. The spectrum approach treats the picture as waves, and processes the picture as signals. The searching point, line and border method or region growing method does not generate a desired result for separating the picture and text. On the other hand, the Fourier transformation or wavelet transformation approach has a greater demand on hardware, and the cost is higher.

Therefore, the present invention aims to provide a system for differentiating pictures and texts that is more efficient and simpler to overcome the aforesaid problems.

### SUMMARY OF THE INVENTION

Accordingly, the object of the invention is to provide a system and method for differentiating pictures and texts to differentiate picture data and text image data in image files in a more efficient and simpler fashion to facilitate data processing in the image processing equipment at later stages or data transmission through networks.

In one aspect, the invention provides a system and method to differentiate picture data and text image data in an image file. The image file corresponds to a picture which includes a plurality of pixels. Each pixel corresponds to a gray-level. The differentiating system includes a threshold setting module and a picture text differentiating module.

The threshold setting module performs statistics of all pixels of the picture to generate a relationship between the gray-level and quantity, and based on the relationship to set a threshold according to a preset rule.

The picture text differentiating module first divides the picture into a plurality of unit areas of the same size. Each unit area contains same number of pixels. Then the picture text differentiating module sequentially performs statistics of the gray-level of the pixels of each unit, and sequentially compares the gray-level with the threshold, and totals the times that the gray-level equals to the threshold.

Later on the picture text differentiating module compares the times of equality with a preset comparison value. When the times of equality is greater than the comparison value, the data corresponding to the unit area is treated as picture data. When the times of equality is smaller than the comparison value, the data corresponding the unit area is treated as text image data.

In another aspect, the differentiating system further includes an error correction module. When the data corresponding to the unit area that are confirmed by the picture text differentiating module differ from the corresponding data of at least three neighboring unit areas of the unit area, the error correction module changes the corresponding data of the unit area to the different data.

In yet another aspect, the threshold setting module, based on the setting rule, selects the gray-level corresponding to the smallest quantity among two greatest quantities as the threshold that are obtained according to the relationship between the gray-level and the quantity.

In still another aspect, the threshold setting module, based on the setting rule, selects the average of two gray-levels corresponding to two greatest quantities as the threshold that are obtained according to the relationship between the gray-level and the quantity.

Hence, by means of the system and method for differentiating 25 pictures and texts of the invention, the threshold setting module generates a threshold, the picture text differentiating module sequentially compares the gray-level of a plurality of pixels with the threshold, by comparing the times of equality, differentiating of picture data and text image data in the image file can be accomplished efficiently and simply to facilitate data processing in the image processing equipment at later stages or data transmission through the networks.

### BRIEF DESCRIPTION OF THE DRAWINGS

The present invention will now be specified with reference to its preferred embodiment illustrated in the drawings, in which

FIG.1 is a schematic view of the differentiating system of the invention;

FIG.2 is a schematic view of the image of the invention;

FIG. 3a is a chart showing the times of equality of picture data;

FIG. 3b is a chart showing the times of equality of text image data;

FIG. 4 is a chart showing a first embodiment of the setting threshold according to the invention;

FIG. 5 is a chart showing a second embodiment of the setting threshold according to the invention; and

FIG. 6 is a flow chart of the differentiating method of the invention.

### DESCRIPTION OF THE PREFERRED EMBODIMENTS

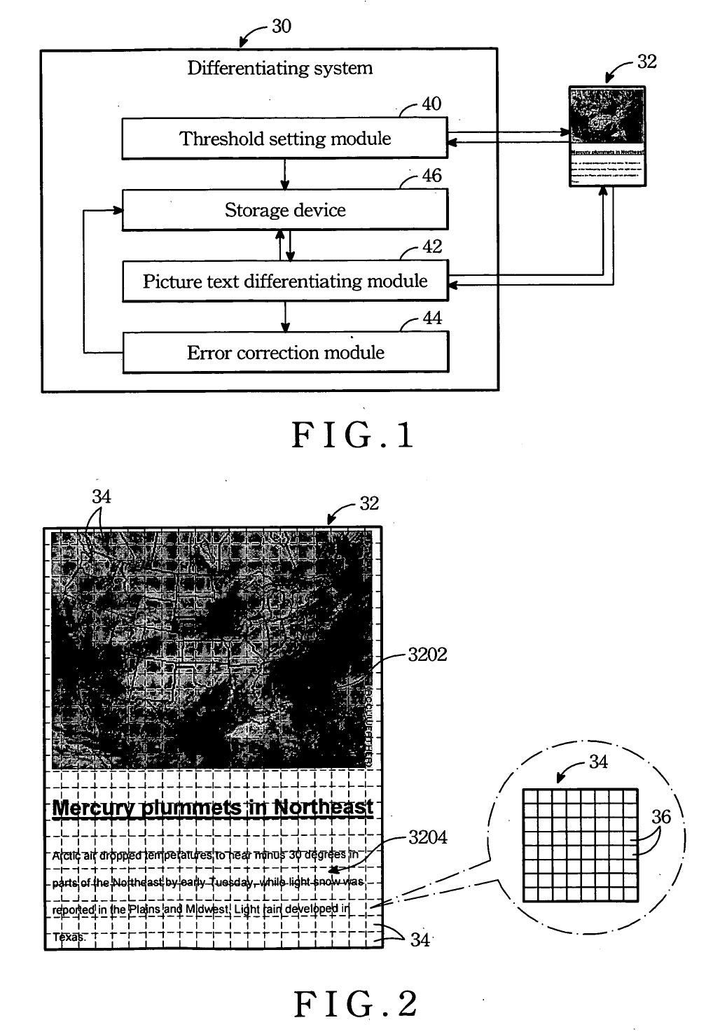

Refer to FIG. 1 for the schematic view of a differentiating system 30, and FIG. 2 for an image 32 according to the invention. The differentiating system 30 aims to differentiate picture data and text image data in an image file.

Referring to FIG. 2, the image 32 corresponding to the image file includes a plurality of pixels 36. Each pixel 36 corresponds to a gray-level. The picture data and text image data in the image 32 correspond respectively to a picture 3202 and a text 3204. In one aspect, the image 32 is divided into a plurality of unit areas 34 of the same size. Each of the unit areas 34 contains a plurality of pixels 36 of the same number.

Referring to FIG. 1, the differentiating system 30 includes a threshold setting module 40, a picture text differentiating module 42 and an error correction module 44.

The threshold setting module 40 performs statistics of all pixels 36 to generate a relationship between the gray-level and quantity. Namely, calculate the quantity of the pixels 36 corresponding to each gray-level. The threshold setting module 40, based on the relationship of the gray-level and the quantity and a preset rule, sets one threshold. The-threshold is stored in a storage device 46. The preset rule may vary. Two embodiments are discussed below.

Referring to FIG. 2, in the unit area 34, the picture text differentiating module 42 sequentially performs statistics of the gray-levels of the pixels 36, and sequentially compare the gray-levels with the threshold. The sequence may be from left to right according to the layout sequence of the pixels 36, and from top to bottom by rows; or from left to right and top to bottom according to the layout sequence of the pixels 36, or other preset sequences.

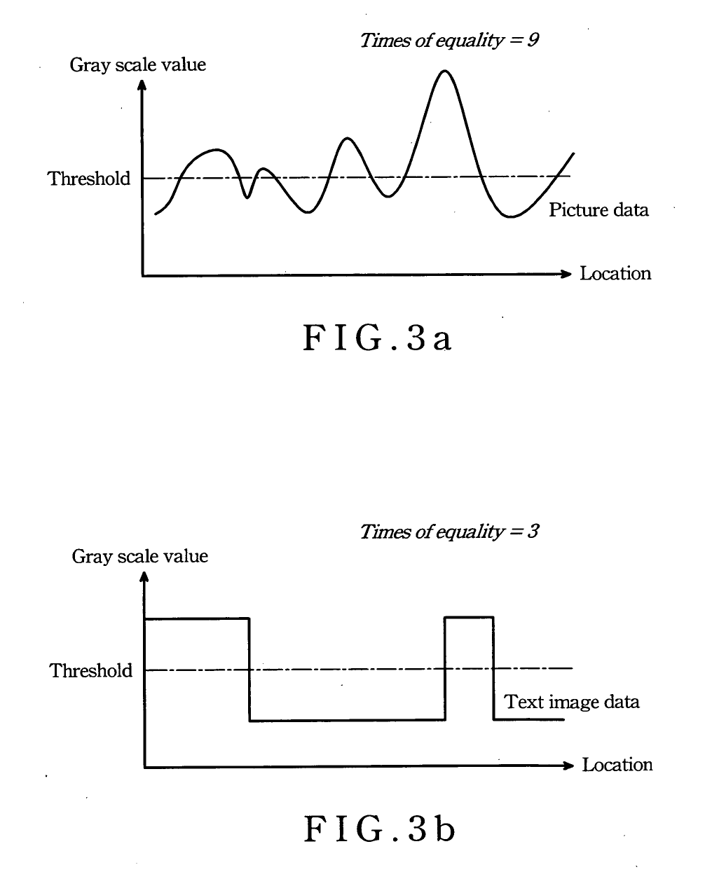

Referring to FIGS. 1, 2, and 3a and 3b that show the times of equality of the picture and text image data. In FIGS. 3a and 3b, the horizontal coordinate indicates sequential scanning position of the picture text differentiating module 42, the vertical coordinate indicates the gray-level. The threshold confirmed by the threshold setting module 40 is indicated by the horizontal line in the drawings.

-The picture text differentiating module 42 accumulates the times of equality of the comparison between the gray-level and the threshold. The times of equality is the times the curve crossing the horizontal line of the threshold in the drawings. For instance, it is nine times in FIG, 3a, and three times in FIG. 3b. The picture text differentiating module 42 compares the times of equality with a preset comparison value in the later stage process.

As the alteration of the gray-level of the picture data is more complicated, their times of equality also is greater. The alteration of the gray-level of the text image data is simpler, hence their times of equality also is less. Hence when the times of equality of the unit area 34 is greater than the comparison value, the data corresponding to the unit area 34 is treated as picture data. When the times of equality of the unit area 34 is less than the comparison value, the data corresponding to the unit area 34 is treated as text image data.

For instance, in the enlarged drawing shown in FIG. 2, the unit area 34 has 8*8 units of pixels 36. Namely the picture text differentiating module 42 scans 64 units of the pixels 36. The comparison value may be set 5. If the times of equality of the unit area 34 is greater than 5, such as 9 in FIG. 3a, it indicates that alteration of the gray-level is complicated, hence the data is treated as a picture. On the contrary, if the times of equality is less than 5, as shown in FIG. 3b that is 3, it indicates that alteration of the gray-level is simple, hence the data is treated as a text.

Referring to FIG. 1 again, after the picture text differentiating module 42 has confirmed the data corresponding to the unit area 34, it compares four neighboring unit areas 34. If there are at least three neighboring unit areas 34 that have different corresponding data, the error correction module 44 changes the data corresponding to the unit area 34 to the different data. For instance, if the data in the unit area 34 has been confirmed by the picture text differentiating module 42 to be a text image data, but the corresponding data of three or four neighboring unit areas 34 are picture data, the error correction module 44 changes the text image data in the unit area 34 to the picture data. Thereby the chance of mistaken determination is reduced to facilitate follow on data processing.

Finally, the picture data and text image data confirmed by the error correction module 44 are stored in the storage device 46. The data stored in the storage device 46 is retrieved for later data processing performed by the image processing equipment, or for data transmission through the networks,

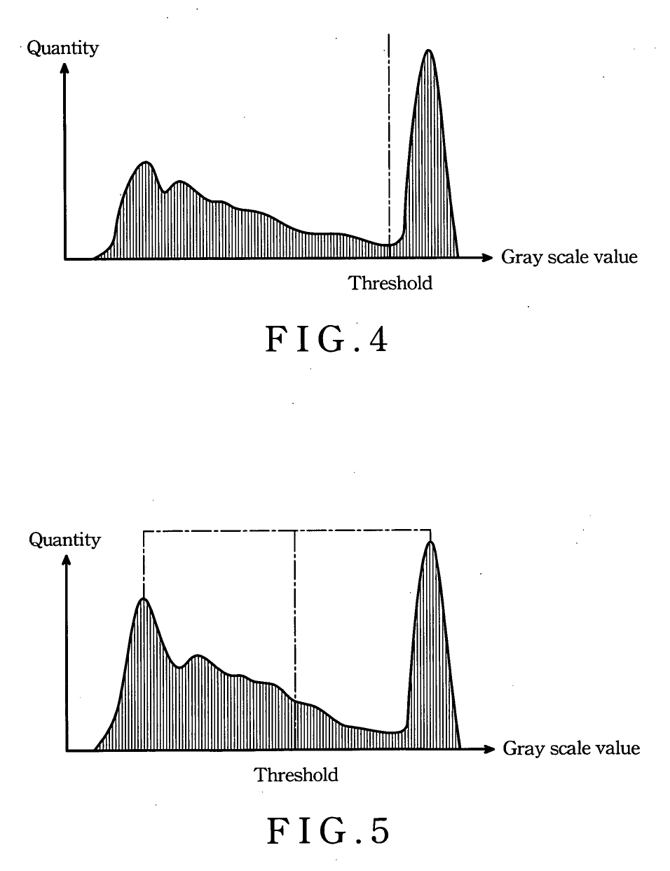

Refer to FIG. 4 for a first embodiment of the invention for setting the threshold. As previously discussed for the differentiating system 30, the threshold setting module 40, based on the setting rule and the relationship between the gray-level and quantity, selects the gray-level corresponding to the smallest quantity among two greatest quantities as the threshold.

Refer to FIG. 5 for a second embodiment of the invention for setting the threshold. As previously discussed for the differentiating system 30, the threshold setting module 40, based on the setting rule and the relationship between the gray-level and quantity, takes the average of two gray-levels corresponding to the two greatest quantities as the threshold.

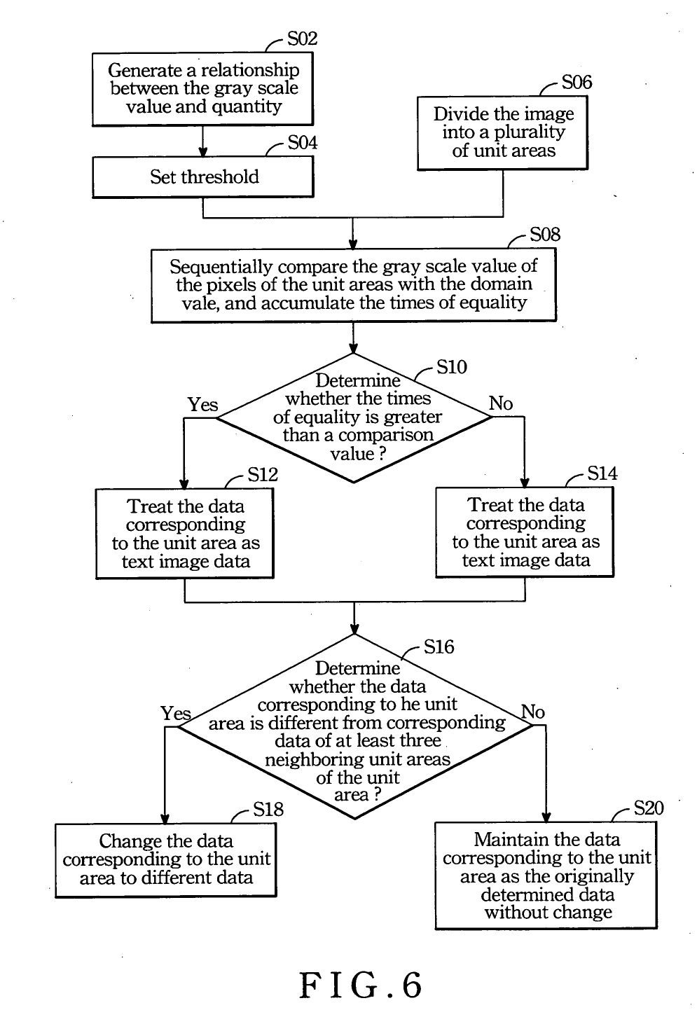

Refer to FIG. 6 for the process flow of the differentiating method of the invention to differentiate picture data and text image data that is performed by the differentiating system 30 previously discussed. The image file corresponding to the image 32 contains a plurality of pixels 36. Each unit of the pixels 36 corresponds to a gray-level. The differentiating method includes the following steps:

Step S02: Perform statistics of all pixels 36 of the image 32 to generate a relationship between the gray-level and quantity (the number of the pixels 36).

Step S04: After step S02, based on the relationship between the gray-level and quantity, set a threshold according to a preset setting rule. The method for setting the threshold may refer to the embodiments shown in FIGS. 4 and 5.

Step S06: Divide the image 32 into a plurality of unit areas 34 of the same size. Each of the unit areas 34 contains a plurality of pixels 36 of the same number.

Step S08: Perform statistics sequentially of the gray-levels of the pixels 36 in each unit area 34, and compare the gray-level with the threshold, and accumulate the times of equality between the gray-level and the threshold.

Step S10: After step S08, compare the times of equality with a preset comparison value to determine whether the times of equality is greater than the comparison value.

Step S12: Treat the data corresponding to the unit area 34 as picture data when the times of equality is greater than the comparison value.

Step S14: Treat the data corresponding to the unit area 34 as text image data when the times of equality is less than the comparison value.

Step S16: Perform error corrections for step S12 and step S14. Determine whether the data corresponding to the unit area 34 is different from the data corresponding to at least three neighboring unit areas 34.

Step S18: Change the data corresponding to the unit area 34 to the different data when the picture text differentiating module 42 confirms that the data corresponding to the unit area 34 is different from the data corresponding to at least three neighboring unit areas 34.

Step S20: Maintain the data corresponding to the unit area 34 unchanged from the original determination when the picture text differentiating module 42 confirms that the data corresponding to the unit area 34 is not different from the data corresponding to at least three neighboring unit areas 34. Thereby the picture data and the text image data in the image file may be differentiated.

Therefore, by means of the system and method for differentiating picture and text of the invention, the threshold setting module 40 can generate the threshold, and the picture text differentiating module 42 compares sequentially the gray-level of a plurality of pixels 36 in the unit area 34 with a threshold, and by comparing the times of equality, the picture data and the text image data in the image file may be differentiated efficiently and easily for the image processing equipment to do data processing in the later stages, or for data transmission through the networks.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

I claim:

1. A system for differentiating pictures and texts to differentiate picture data and text image data in an image file, a image generated from the image file containing a plurality of pixels with each pixel corresponding to a gray-level, the system comprising:
a threshold setting module for performing statistics all the pixels of the images to generate a relationship between the gray-level and quantity, and setting a threshold according to the relationship between the gray-level and quantity; and
a picture text differentiating module to divide the images to a plurality of unit areas of a same size, each of the unit areas containing a plurality of pixels, the picture text differentiating module comparing sequentially the gray-level of the pixels in the unit areas with the threshold, and totaling the times that the gray-level equals to the threshold, and comparing the times of equality with a preset comparison value;
wherein data corresponding to the unit area is treated as the picture data when the times of equality is greater than the comparison value, and the data corresponding to the unit area is treated as the text image data when the times of equality is less than the comparison value.

2. The system for differentiating pictures and texts of claim 1 further including an error correction module to change the data corresponding to the unit area to different data when the picture text differentiating module has confirmed that the data corresponding to the unit area being different from corresponding data of at least three neighboring unit areas of the unit area.

3. The system for differentiating pictures and texts of claim 1, wherein the preset setting rule is to select the gray-level corresponding to the least quantity as the threshold among two greatest quantities derived based on the relationship between the gray-level and quantity.

4. The system for differentiating pictures and texts of claim 1, wherein the preset setting rule is to take the average of two gray-levels corresponding to two greatest quantities derived based on the relationship between the gray-level and quantity as the threshold.

5. A method for differentiating pictures and texts to differentiate picture data and text image data in an image file, a image generated from the image file containing a plurality of pixels with each pixel corresponding to a gray-level, the method comprising the steps of:
performing statistics of all the pixels to generate a relationship between the gray-level and quantity;
setting a threshold according to the relationship between the gray-level and quantity;
dividing the images into a plurality of unit areas of a same size, each of the unit areas containing a plurality of pixels of a same number;
comparing sequentially the gray-level of the pixels in the unit areas with the threshold, and totaling the times that the gray-level equals to the threshold; and
comparing the times of equality with a preset comparison value, treating data corresponding to the unit area as the picture data when the times of equality is greater than the comparison value, and treating the data corresponding to the unit area as the text image data when the times of equality is less than the comparison value.

6. The method of claim 5 further including the step of changing the data corresponding to the unit area to different data when the data corresponding to the unit area being different from corresponding data of at least three neighboring unit areas of the unit area.

7. The method of claim 5, wherein the preset setting rule is to select the gray-level corresponding to the least quantity as the threshold among two greatest quantities derived based on the relationship between the gray-level and quantity.

8. The method of claim 5, wherein the preset setting rule is to take the average of two gray-levels corresponding to two greatest quantities derived based on the relationship between the gray-level and quantity as the threshold.
